(19) United States
(12) Patent Application Publication
(10) Pub. No.: US 2026/0056148 A1
(43) Pub. Date: Feb. 26, 2026

(54) PROCESSING APPARATUS, SYSTEM, METHOD, AND PROGRAM FOR CALCULATING A STRUCTURAL FACTOR

(71) Applicant: RIGAKU CORPORATION, Tokyo (JP)

(72) Inventors: Masatsugu YOSHIMOTO, Tokyo (JP); Kazuki ITO, Tokyo (JP); Kazuhiko OMOTE, Tokyo (JP)

(73) Assignee: RIGAKU CORPORATION, Tokyo (JP)

(21) Appl. No.: 19/304,634

(22) Filed: Aug. 20, 2025

(30) Foreign Application Priority Data
Aug. 22, 2024 (JP) 2024-141005

(51) Int. Cl. G01N 23/207; G01N 23/223

(52) U.S. Cl. CPC G01N 23/207; G01N 23/223

(57) ABSTRACT

A system capable of calculating a structure factor of a thin film formed on a substrate includes a measurement data acquiring section, a total scattering data calculating section, and a structure factor calculating section. The processing apparatus is configured to be capable of calculating a structure factor of a film formed on a substrate. The total scattering data calculating section acquires first total scattering data Iₛₚ and second total scattering data I_{sub} from the measurement data acquiring section, and calculates total scattering data I_{TF} of only a film portion based thereon. The total scattering data I_{TF} of only the film portion is determined by subtracting a product of the second total scattering data I_{sub} and an absorption factor A_{sub} of the substrate from the first total scattering data Iₛₚ.

### CROSS-REFERENCE TO RELATED APPLICATION

This application claims priority from Japanese Patent Application No. 2024-141005, filed on Aug. 22, 2024, the entire contents of which are incorporated by reference in this application.

### BACKGROUND

### Field

The present invention relates to a processing apparatus, a system, a method, and a program that are capable of calculating a structure factor.

### Description of the Related Art

In order to appropriately grasp functions of material, information about the three-dimensional structure of the material is essential. Since many of conventional materials have been crystalline materials with regularity, their crystal structure were determined by an X-ray analysis method capable of analyzing material with regularity, thereby obtaining information on their three-dimensional structure. In the recent fields of batteries, electronics, and the like, many amorphous materials with actively reduced regularity are also being used to maximize intended functions and physical properties.

Recently, pair distribution function (PDF) analysis has been researched as a method for analyzing amorphous material using an X-ray. In the PDF analysis, the structure factor of a sample is calculated from data obtained by total scattering measurement. To avoid complications in this calculation process, the shape of the measurement sample is restricted. For example, in the case of a thin film sample formed on a substrate, a method of peeling a film portion from the substrate and causing the film portion to be in a measurable powder form is conceivable. In such a method, however, there is a possibility that the structure of the sample changes due to physical influence in the process from peeling to powdering. Therefore, there is a demand for a method capable of analyzing a thin film sample in a state of being formed on a substrate.

Conventionally, methods for performing measurement for a thin film sample have been proposed. The penetration depth of an X-ray into a thin film sample is reduced by causing the X-ray to be obliquely incident on the thin film sample, and total scattering data of the X-ray is obtained from the thin film sample to obtain the scattering intensity of the thin film sample (Non-patent Document 1).

### Non-Patent Document

Non-patent Document 1: A.-C. Dippel, M. Roelsgaard, U. Boettger, T. Schneller, O. Gutowski, U. Ruett, IUCrJ. 6(2019) 290-298.

### SUMMARY

However, the total scattering data obtained by irradiating a thin film sample on a substrate with an X-ray includes pieces of total scattering data from both of the substrate and the thin film sample. Therefore, in order to obtain total scattering data of only the thin film sample formed on the substrate, it is necessary to eliminate influence of the substrate from the obtained total scattering data by some method. Such a method, however, is not disclosed in A.-C. Dippel, M. Roelsgaard, U. Boettger, T. Schneller, O. Gutowski, U. Ruett, IUCrJ. 6(2019) 290-298, which has been described above.

The present invention has been made in view of such a problem, and an object thereof is to provide a processing apparatus, a system, a method, and a program that are capable of calculating a structure factor of a thin film formed on a substrate.

(1) In order to achieve the above object, a processing apparatus according to the present invention is a processing apparatus capable of calculating a structure factor of a film portion formed on a substrate, and the processing apparatus includes: a data acquiring section acquiring first total scattering data obtained by performing measurement for a first sample including the substrate and the film portion under a measurement condition of an X-ray being obliquely incident, and second total scattering data obtained by performing measurement for a second sample including the first sample except the film portion under the measurement condition; a total scattering data calculating section calculating total scattering data of the film portion based on the first total scattering data and the second total scattering data; and a structure factor calculating section calculating a structure factor of the film portion based on the total scattering data of the film portion.

(2) It is preferable that the total scattering data calculating section calculates the total scattering data of the film portion by subtracting a product of the second total scattering data and an absorption factor of the substrate from the first total scattering data.

(3) It is preferable that the total scattering data calculating section calculates the absorption factor of the substrate based on an X-ray incidence angle, diffraction angle, film thickness of the film portion, an absorption coefficient of the film portion, and/or a refractive index of the film portion.

(4) It is preferable that the measurement condition has information about an X-ray incidence angle, and the X-ray incidence angle is equal to or smaller than twice a total internal reflection critical angle.

(5) A system according to the present invention includes an X-ray diffractometer comprising an X-ray generator generating an X-ray, an X-ray detector detecting the X-ray, a sample stage where a sample is arranged, and a goniometer controlling an angle formed by the X-ray generated by the X-ray generator and a surface of the sample and an angle formed by the X-ray received by the X-ray detector and the surface of the sample, and the processing apparatus described above; and the X-ray diffractometer generates the first total scattering data and the second total scattering data using the X-ray generator, the X-ray detector, and the goniometer.

(6) It is preferable that the system according to the present invention further includes a measurement condition deciding section that decides the measurement condition, and the measurement condition has information about an X-ray incidence angle, and the measurement condition deciding section decides X-ray incidence angles for the first sample and the second sample based on film thickness of the film portion, an absorption coefficient of the film portion, and/or a total internal reflection critical angle between the first sample and the X-ray.

(7) The system according to the present invention may further include a sample information acquiring section, the sample information acquiring section determining the film thickness of the film portion and a density of the film portion or the total internal reflection critical angle of the film portion by an X-ray reflectivity measurement method based on the data obtained using the X-ray diffractometer.

(8) The system according to the present invention may further include a correlation calculating section, the correlation calculating section determining correlation among atoms included in the film portion based on the structure factor of the film portion.

(9) A program according to the present invention is a program that is capable of calculating a structure factor of a film portion formed on a substrate and is executed by a computer, and the program includes: acquiring first total scattering data obtained by performing measurement for a first sample including the substrate and the film portion under a measurement condition of an X-ray being obliquely incident; acquiring second total scattering data obtained by performing measurement for a second sample including the first sample except the film portion under the measurement condition; calculating total scattering data of the film portion based on the first total scattering data and the second total scattering data; and calculating a structure factor of the film portion based on the total scattering data of the film portion.

(10) A method according to the present invention is a method capable of calculating a structure factor of a film portion formed on a substrate, and the method includes: acquiring first total scattering data obtained by performing measurement for a first sample including the substrate and the film portion under a measurement condition of an X-ray being obliquely incident; acquiring second total scattering data obtained by performing measurement for a second sample including the first sample except the film portion under the measurement condition; calculating total scattering data of the film portion based on the first total scattering data and the second total scattering data; and calculating a structure factor of the film portion based on the total scattering data of the film portion.

According to the present invention, it is possible to provide a processing apparatus, a system, a method, and a program that are capable of calculating a structure factor of a thin film formed on a substrate.

### BRIEF DESCRIPTION OF THE DRAWINGS

FIG. 1 is a block diagram schematically showing a processing apparatus 100 according to one embodiment of the present invention.

FIG. 2 is a diagram schematically showing a relationship between an X-ray and a sample.

FIG. 3 is a diagram showing a relationship between an incidence angle θᵢₙ of the X-ray relative to the sample and an incidence angle θ_{R} relative to a film portion.

FIG. 4 is a block diagram schematically showing a system 10 according to the one embodiment of the present invention.

FIG. 5 is a flowchart showing a measurement process according to the one embodiment of the present invention.

FIG. 6 is a flowchart showing a sample position adjustment process according to the one embodiment of the present invention.

FIG. 7 is a flowchart showing a total scattering data acquisition process according to the one embodiment of the present invention.

FIG. 8 is a diagram showing a result of measuring X-ray reflectivity by an X-ray reflectivity measurement method using the MoKα wavelength.

FIG. 9 is a diagram showing a relationship between a diffraction angle 2θ and an absorption factor A(θ) of a substrate.

FIG. 10 is a diagram showing total scattering data of a sample obtained by forming an ITO film on a glass substrate, total scattering data of the glass substrate, and data obtained by extracting total scattering data only of the film portion from the pieces of total scattering data.

FIG. 11 is a diagram showing scattering intensity of a sample normalized to an atomic scattering factor.

FIG. 12 is a diagram showing a structure factor of the film portion.

### DETAILED DESCRIPTION

Next, an embodiment of the present invention will be described with reference to the drawings. In order to make it easy to understand the description, components that are the same in the drawings will be given the same reference number, and duplicate description will be omitted.

### Embodiment

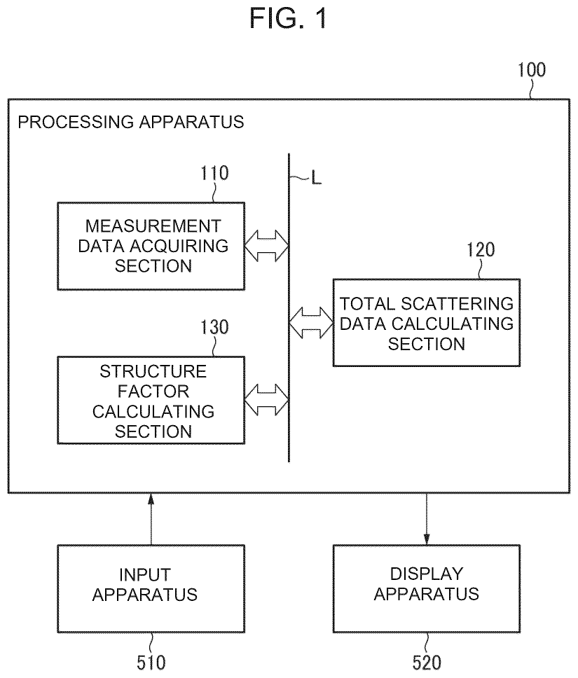

A processing apparatus 100 according to one embodiment of the present invention will be described with reference to FIG. 1. The processing apparatus 100 is, for example, a computer configured by connecting members, such as a central processing unit (CPU), a read-only memory (ROM), a random access memory (RAM), interfaces, and a memory, to a bus L, and mainly includes a measurement data acquiring section 110, a total scattering data calculating section 120, and a structure factor calculating section 130. The measurement data acquiring section 110, the total scattering data calculating section 120, and the structure factor calculating section 130 are realized by each of the members of the computer described above. The processing apparatus 100 is configured to be capable of calculating a structure factor of a film formed on a substrate.

Each of the measurement data acquiring section 110, the total scattering data calculating section 120, and the structure factor calculating section 130 is configured to be capable of transmitting/receiving information via the control bus L.

The processing apparatus 100 can be connected to a measurement apparatus such as an X-ray diffractometer 300, for example, via a control apparatus 200 described later.

An input apparatus 510 and a display apparatus 520 are connected to the CPU of the processing apparatus 100 via interfaces. The input apparatus 510 includes, for example, a keyboard and a mouse to input to the processing apparatus 100. The display apparatus 520 is, for example, a display, and displays total scattering data, measurement conditions, a structure factor, a PDF, and the like.

The measurement data acquiring section 110 acquires total scattering data of a sample from outside of the processing apparatus 100. The total scattering data of the sample is measured by the X-ray diffractometer 300.

In the present embodiment, a sample includes a first sample obtained by forming a thin film (hereinafter referred to as a film portion) on the surface of a substrate and a second sample consisting only of the substrate. The first sample includes the substrate made of, for example, glass and the film portion formed on the surface of the substrate.

As examples of the sample, there can be a sample consisting of one substrate and a sample consisting of two substrates. In the case of the sample consisting of one substrate, a film portion is formed on a part of the substrate, and only the substrate appears on the other part of the substrate. The sample consisting of two substrates includes a first substrate, which is one substrate with a film portion provided thereon, and a second substrate consisting of only the substrate. When a sample consists of one substrate, measurement is performed for a part on which a film portion is formed (the first sample) and a part consisting of only the substrate (the second sample), and two kinds of total scattering data are obtained. When a sample consists of two substrates, measurement is performed for each of the first substrate on which a film portion is formed (the first sample) and the second substrate consisting of only the substrate (the second sample), and two kinds of total scattering data are obtained. In the present specification, total scattering data of the first sample and total scattering data of the second sample will be referred to as first total scattering data and second total scattering data, respectively, and the pieces of total scattering data will be generically referred to as total scattering data of the sample.

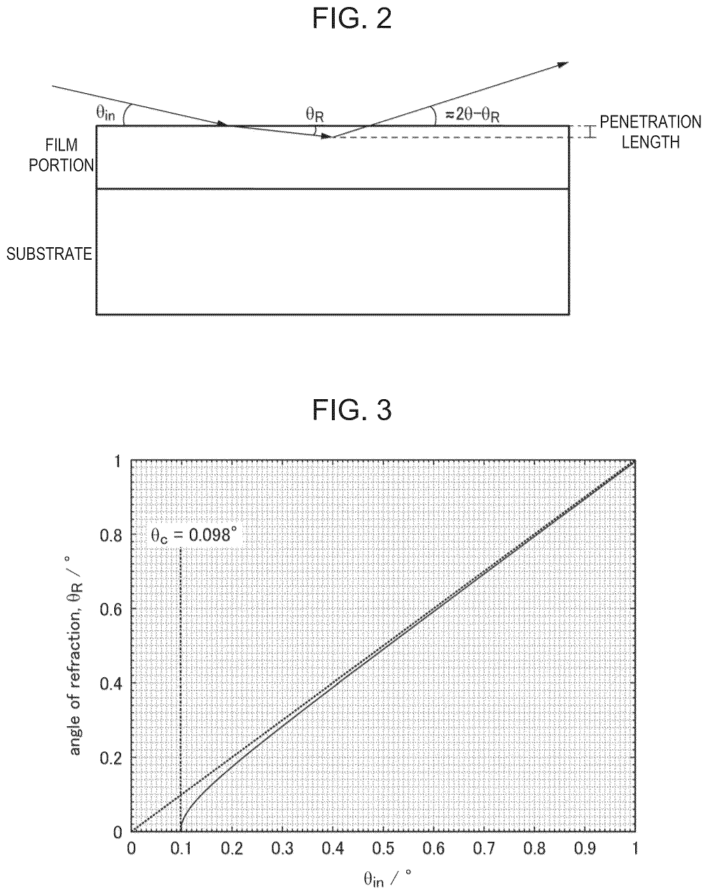

The total scattering data of the sample is obtained by a measurement method in which an X-ray is obliquely incident on the sample. In this method, an incidence angle θᵢₙ of the X-ray relative to the sample is fixed to an angle equal to or smaller than a predetermined angle to cause the X-ray to be obliquely incident on the sample. Then, a receiving-side optical system is caused to operate on an arc with the sample as the center to measure scattering intensities of the X-ray emitted from the sample. A collection of the plurality of scattering intensities obtained thereby is used as the total scattering data. Each scattering intensity includes a position of a measurement point (a diffraction angle 2θ formed by the receiving-side optical system and the surface of the sample), and the intensity of the X-ray measured at the point; and the total scattering data is a set of values of scattering intensities at a plurality of measurement points. As the predetermined angle, an angle that is a little larger than a total internal reflection critical angle of the film portion is preferable, and the angle is decided according to characteristics of the film portion and the X-ray. As a specific value of the predetermined angle, for example, a value equal to or smaller than 1° is preferable; a value between 0.1° and 0.5° inclusive is more preferable; and a value between 0.1° and 0.3° inclusive is much more preferable. By fixing the incidence angle θᵢₙ of the X-ray to such an angle, it is possible to, for an optical path until the X-ray being emitted at an emission angle θ (≈2θ−θ_{R}) after being incident on the first sample and refracted at a refraction angle θ_{R}, shorten the depth of the X-ray being incident from the surface of the first sample, that is, a penetration length (a penetration depth lₚ) of the X-ray (see FIG. 2). Thereby, it is possible to reduce influence by the substrate on the first total scattering data obtained by measurement. More specifically, it is possible to, at the time of performing measurement for the first sample, reduce scattering intensity generated by the substrate and relatively increase scattering intensity generated by the film portion in the first total scattering data and obtain high-precision measurement data with a low substrate-derived scattering intensity.

It is preferable that the second total scattering data and the first total scattering data are measured under the same measurement conditions. The same measurement conditions stated here refers to performing measurement using the same system, that is, the same processing apparatus and the same X-ray diffractometer and using the same incidence angle θᵢₙ. As for the processing apparatus and the X-ray diffractometer, the wavelength of the generated X-ray, the X-ray receiving sensitivity, and the like slightly change due to deterioration. Therefore, even if apparatuses of the same model number are used, there is a possibility that measurement results are slightly different. Therefore, by performing measurement of the second total scattering data and the first total scattering data with the same processing apparatus and the same X-ray diffractometer using the same incidence angle θ in, it becomes possible to perform measurement, eliminating influence due to deterioration of the apparatuses, and suppressing influence of errors by using the same X-ray penetration length. Furthermore, in the case of performing measurement for a plurality of film portions formed on the same substrate, it is possible to use one piece of second total scattering data measured at one position for a plurality of pieces first total scattering data obtained by performing measurement for the plurality of film portions.

The total scattering data calculating section 120 acquires first total scattering data Iₛₚ and second total scattering data I_{sub} from the measurement data acquiring section 110, and calculates total scattering data I_{TF} Of only a film portion based thereon. For example, as shown by Formula (1), the total scattering data I_{TF} of only the film portion is determined by subtracting a product of the second total scattering data I_{sub} and an absorption factor A_{sub} of the substrate from the first total scattering data Iₛₚ. The absorption factor A_{sub} of the substrate will be described later.

$${I}_{T F} = {I}_{s p} - {A}_{s u b} {I}_{sub} \qquad ( 1 )$$

I_{TF}: total scattering data of film portion
Iₛₚ: first total scattering data
I_{sub}: second total scattering data
A_{sub}: absorption factor of substrate

Another example of the method for calculating the total scattering data of the film portion is shown by Formula (2).

$${I}_{T F} = \frac{{I}_{sp}}{{A}_{sub}} - {I}_{s u b} \qquad ( 2 )$$

Formula (2) is substantially the same as Formula (1), being different from Formula (1) only in the intensity of the total scattering data of the film portion and being the same in the other points. The reason is as follows. When both sides of Formula (2) are multiplied by A_{sub}, the left-hand side of Formula (2) becomes I_{TF}•A_{sub}, which is a value obtained by multiplying the total scattering data I_{TF} of film portion on the left-hand side of Formula (1) by A_{sub}. Here, A_{sub} is an approximate constant as described later with reference to FIG. 9. Therefore, Formula (2) and Formula (1) are in a constant multiplication relationship and can be said to be substantially the same.

The absorption factor A_{sub} of the substrate is a value indicating the magnitude of scattering intensity from the substrate, taking into account attenuation in the film portion. Here, in the substrate provided with the film portion, the scattering intensity from the substrate includes the following components:
1. Components which have been incident on the film portion and permeated the film portion
2. Components among the components of 1 above, which have reached the substrate and absorbed by the substrate
3. Components of a scattering X-ray that has occurred in the process of 2 above, which have been absorbed by the substrate
4. Components of the scattering X-ray that has occurred in the process of 2 above, which have permeated the film portion

Since the components of 2 and 3 above can be obtained by measuring scattering intensity for a part including only the substrate (the second sample), the components of 1 and 4 above are considered at the time of determining the absorption factor A_{sub} of the substrate used in Formula (2). For example, the absorption factor A_{sub} of the substrate is a ratio of the scattering intensity from the substrate provided with the film portion to the scattering intensity of only the substrate. At this time, the value of the absorption factor A_{sub} of the substrate is 1 when the film portion is not provided, and is 0 when the thickness of the film portion is infinitely thick. A method for calculating the absorption factor A_{sub} of the substrate is shown by Formula (3). Referring to Formula (3), the absorption factor A_{sub} of the substrate is determined by multiplying the optical path length of the X-ray which, after permeating the film portion and reaching the substrate, permeates the film portion and is emitted from the sample by an absorption factor μ_{TF} of the film portion. The absorption factor μ_{TF} of the film portion is calculated based on the transmittance of the film portion determined using the Beer-Lambert Law. Referring to FIG. 2, the optical path length of the X-ray which, after permeating the film portion and reaching the substrate, permeates the film portion and is emitted from the sample is calculated using a thickness t_{TF} of the film portion, the incidence angle θ_{R} relative to the film portion, and the diffraction angle 2θ.

$$\begin{matrix}{A}_{s u b} = exp ( - {μ}_{TF} {t}_{TF} ( \frac{1}{sin {θ}_{R}} + \frac{1}{sin ( 2 θ \to {θ}_{R} )} ) ) \\ = exp ( - 2 {μ}_{TF} {t}_{TF} \frac{sin θ cos ( θ - {θ}_{R} )}{sin {θ}_{R} sin ( 2 θ - {θ}_{R} )} )\end{matrix} \qquad ( 3 )$$

μ_{TF}: absorption factor of film portion
t_{TF}: thickness of film portion
θ_{R}: incidence angle of X-ray to film portion
2θ: diffraction angle

Here, for example, when the X-ray is extremely shallowly incident on the sample in the case of the incidence angle θ_{R}<<the diffraction angle 2θ, an optical path from scattering of the X-ray till emission from the sample is extremely short. Therefore, the value of the second term (1/sin(2θ−θ_{R})) of Formula (3) corresponding to the length of the optical path is a negligibly small value. Therefore, an expression without the second term may be used. Here, the value of the absorption factor A_{sub} of the substrate takes an approximately constant value as described later with reference to FIG. 9. Therefore, even if the expression without the second term is used, the conclusion is hardly influenced.

The incidence angle θ_{R} of the film portion is determined from the incidence angle θᵢₙ of the X-ray relative to the sample and a complex refractive index n⁺ of material relative to the X-ray. The complex refractive index n′ of material relative to the X-ray is shown by Formula (4), and the incidence angle θ_{R} relative to the film portion is shown by Formula (5).

$${n}^{*} = 1 - δ - i β \qquad ( 4 )$$

$$wherein$$

$$δ = \frac{{r}_{e}}{2 π} {λ}^{2} {N}_{A} ρ \frac{{\sum }_{i} {c}_{i} ( {Z}_{i} + {f}_{i}^{′} )}{{\sum }_{i} {c}_{i} {M}_{i}}$$

$$β = \frac{{r}_{e}}{2 π} {λ}^{2} {N}_{A} ρ \frac{{\sum }_{i} {c}_{i} ( {f}_{i}^{″} )}{{\sum }_{i} {c}_{i} {M}_{i}}$$

n⁺: complex refractive index
γₑ: classical electron radius
λ: wavelength of X-ray
N_{A}: Avogadoro's number
ρ: density
zᵢ, Mᵢ, cᵢ: atomic number, atomic weight, and atomic ratio of the i-th atom
fᵢ′, fᵢ″: atomic scattering factor of the i-th atom

$$sin {θ}_{R} = \frac{1}{1 - δ} \sqrt{- 2 δ + {sin}^{2} {θ}_{i n}} \qquad ( 5 )$$

θᵢₙ: incidence angle of X-ray relative to sample

The refractive index of material relative to an X-ray is indicated by the real part of the complex refractive index n⁺ shown by Formula (4), and it is a value slightly smaller than 1. In a case where an X-ray is incident on the sample with an angle equal to or smaller than the constant incidence angle θ_{R}, the complex refractive index n′ is an imaginary number, and the film-portion incidence angle θ_{R}, which is a real part, cannot be defined. Therefore, a phenomenon that the X-ray is totally reflected by the sample surface occurs. The incidence angle of the X-ray relative to the sample at that time is referred to as a total internal reflection critical angle θ_{c}. The total internal reflection critical angle θ_{c} is shown by Formula (6). Note that, as shown by Formula (6), the real parts of the total internal reflection critical angle θ_{c} and the complex refractive index n′ are in a commutative relationship.

$${θ}_{c} = \sqrt{2 δ} \qquad ( 6 )$$

θ_{c}: total internal reflection critical angle

FIG. 3 shows a relationship between the incidence angle θᵢₙ of the X-ray relative to the sample and the incidence angle θ_{R} relative to the film portion when the total internal reflection critical angle θ_{c} is 0.098°. It is seen that, when an X-ray is incident on the sample at an angle a little larger than the total internal reflection critical angle θ_{c}, the incidence angle θ_{R} relative to the film portion is almost 0. By causing an X-ray to be incident on the sample at an angle a little larger than the total internal reflection critical angle θ_{c}, utilizing the above phenomenon, it is possible to increase the optical path length of the X-ray in the film portion and, thereby, obtain a larger scattering intensity of the film portion. Furthermore, it is seen that, when an X-ray is incident at an angle equal to or larger than twice the total internal reflection critical angle θ_{c}, the values of the incidence angle θᵢₙ of the X-ray relative to the sample and the incidence angle θ_{R} relative to the film portion are close to each other. Therefore, it is preferable that the incidence angle θᵢₙ of an X-ray relative to the sample is equal to or smaller than twice the total internal reflection critical angle θ_{c}.

The incidence angle θᵢₙ of the X-ray relative to the sample can be set to such a value that the X-ray is sufficiently absorbed by the film portion. This value is decided, for example, based on the penetration depth lₚ of the X-ray into the film portion, which is shown by Formula (7). The penetration depth lₚ determined by Formula (7) indicates film thickness at which the intensity of the X-ray which penetrates the film portion and is emitted is attenuated to 1/e. As an example, the incidence angle θᵢₙ is decided in consideration of the thickness t_{TF} of the film thickness and the penetration depth lₚ, and the incidence angle θᵢₙ of the X-ray relative to the sample is decided, for example, such that the thickness t_{TF} of the film portion is equal to or larger than a positive real number multiple (for example, one time, twice, three times) the penetration depth lₚ. For the positive real number multiple, it is preferable to set a value equal to or larger than 1 so that the X-ray is sufficiently absorbed by the film portion. By using a constant multiple like the positive real number multiple, it is possible to easily decide the incidence angle θᵢₙ. Here, since the penetration depth lₚ of an X-ray into the film portion can be determined from the absorption factor UTE of the film portion (Formula (8)) and the total internal reflection critical angle θ_{c}, the incidence angle θᵢₙ of an X-ray relative to the sample can be decided based on the thickness t_{TF} of the film portion, the absorption factor μ_{TF} of the film portion, and the total internal reflection critical angle θ_{c}. Note that, as shown by Formula (8), the imaginary part of the complex refractive index n⁺ and the absorption factor μ_{TF} are in a commutative relationship.

$${l}_{P} = \frac{λ}{4 π β} \sqrt{\frac{{sin}^{2} {θ}_{i n} - 2 δ}{2} \sqrt{\frac{{( {sin}^{2} {θ}_{in} - 2 δ )}^{2} + {β}^{2}}{4}}} \qquad ( 7 )$$

lₚ: penetration depth

$${μ}_{T F} = \frac{4 π}{λ} β \qquad ( 8 )$$

The structure factor calculating section 130 determines a structure factor of the film portion using the total scattering data of the film portion determined by the above method. As for a method for conversion from the total scattering data to a scattering vector, a publicly known method can be used. For example, the structure factor calculating section 130 performs, for the total scattering data of the film portion, standardization and the like by the background, absorption correction, deflection correction, atomic scattering factor, and Compton scattering to determine the structure factor of the film portion. The determined structure factor of the film portion may be displayed in a state of the structure factor or may be inverse-Fourier transformed and displayed in a state of a PDF.

The structure factor is calculated by Formula (9).

$$S ( Q ) = \frac{α {I}_{T F} - ( 〈 {f}^{2} 〉 + {I}_{i n c} ) + {〈 f 〉}^{2}}{{〈 f 〉}^{2}} \qquad ( 9 )$$

$$〈 {f}^{2} 〉 = {\sum }_{i} {c}_{i} {f}_{i}^{2}$$

$$〈 f 〉 = {\sum }_{i} {c}_{i} {f}_{i}$$

α: standardization coefficient, I_{TF}: total scattering intensity of film portion, ci, fi: molar concentration and atomic scattering factor of i-th element in sample, I_{inc}: Compton scattering intensity

As described above, according to the processing apparatus 100 according to the present embodiment, it is possible to extract the total scattering intensity of only a film portion formed on a substrate from total scattering data and accurately calculate only the structure factor of the film portion.

### [Whole System]

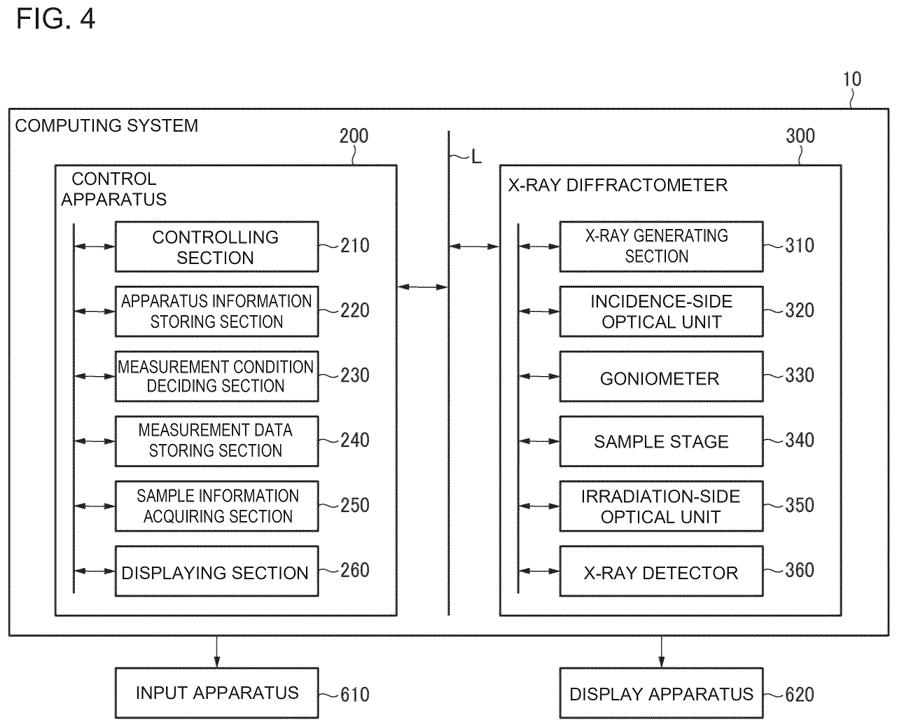

The processing apparatus 100 of the present invention can be included, for example, in a computing system 10. FIG. 4 is a conceptual diagram showing an example of the configuration of the computing system 10. The computing system 10 will be described with reference to FIG. 4. The computing system 10 mainly includes the processing apparatus 100, the control apparatus 200, and the X-ray diffractometer 300.

### [Control Apparatus]

The control apparatus 200 is, for example, a computer configured by connecting a CPU, a ROM, a RAM, interfaces, a display, and a memory to a bus L, and includes a controlling section 210, an apparatus information storing section 220, a measurement condition deciding section 230, a measurement data storing section 240, a sample information acquiring section 250, and a displaying section 260. The controlling section 210, the apparatus information storing section 220, the measurement condition deciding section 230, the measurement data storing section 240, the sample information acquiring section 250, and the displaying section 260 are realized by the above-stated members included in the computer. The control apparatus 200 is connected to the X-ray diffractometer 300 and performs control of the X-ray diffractometer 300, and processing and storage of acquired data. The control apparatus 200 is connected to an input apparatus 610 and a display apparatus 620 via appropriate interfaces. The input apparatus 610 and the display apparatus 620 are different from those connected to the processing apparatus 100.

The controlling section 210 controls operation of the X-ray diffractometer 300, that is, operations of the apparatus information storing section 220, the measurement condition deciding section 230, the measurement data storing section 240, the sample information acquiring section 250, and the displaying section 260.

The apparatus information storing section 220 stores apparatus information acquired from the X-ray diffractometer 300. The apparatus information includes information about the X-ray diffractometer 300 such as the model number of the X-ray diffractometer 300, the type of an X-ray source, an X-ray wavelength, and the background due to the X-ray diffractometer 300, and information specific to the X-ray diffractometer 300 itself. In addition, the apparatus information can include information about all of measurement conditions decided by the measurement condition deciding section 230, which will be described later, the shape, refractive index, and density, types of constituent elements, composition, film thickness, total internal reflection critical angle, and absorption coefficient of the sample, and the like or information among the pieces of information, which is required to obtain measurement data by the X-ray diffractometer 300.

The measurement condition deciding section 230 decides measurement conditions to be applied to the X-ray diffractometer 300 at the time of measurement. The measurement conditions include conditions for an irradiation-side optical system, for example, an incidence angle of an X-ray relative to a sample, and the width of an incidence-side slit, and conditions for a receiving-side optical system, for example, the scan axis, scan range, steps, speed, conditions for a receiving-side slit, and the like. As described above, the measurement condition deciding section 230 can decide the incidence angle of an X-ray based on the film portion thickness t_{TF}, the film portion absorption coefficient μ_{TF}, and the total internal reflection critical angle θ_{c}.

The measurement data storing section 240 stores measurement data acquired from the X-ray diffractometer 300. The measurement data can include, for example, total scattering data and data obtained by measurement according to an X-ray reflectivity measurement method. Furthermore, information similar to that of the apparatus information storing section 220 may be included.

The sample information acquiring section 250 executes the X-ray reflectivity measurement method using the X-ray diffractometer 300 to determine the thickness, density, and total internal reflection critical angle of the film portion. As a method for determining the thickness, density, and total internal reflection critical angle of the film portion by the X-ray reflectivity measurement method, a conventional method can be used. Note that the X-ray diffractometer 300 used to execute the X-ray reflectivity measurement method may be the same as or different from an apparatus used to acquire the total scattering data. Table 1 shows the configuration of an apparatus used to determine the total internal reflection critical angle in the X-ray reflectivity measurement method used in the present embodiment, and Table 2 shows measurement conditions for the total internal reflection critical angle.

TABLE 1
APPARATUS CONFIGURATION

| | |
|---|---|
| X-RAY SOURCE | Mo Kα(λ = 0.7107 Å) |
| FILAMENT TYPE | FINE FOCUS |
| TUBE VOLTAGE-TUBE | 60 kV-150 mA |
| CURRENT | |
| GONIOMETER RADIUS | 300 mm |
| OPTICAL SYSTEM | PB (PARABOLIC MULTILAYER |
| | MIRROR) |
| CBO + SELECTION SLIT | CBO + PB |
| INCIDENT OPTICAL UNIT | INCIDENT SOLAR SLIT 5.0° |
| INCIDENT LENGTH LIMIT | 10 mm |
| SLIT | |
| INCIDENCE-SIDE ANTI- | NOT USED |
| SCATTER PARTS | |
| ATTACHMENT BASE | STANDARD ATTACHMENT |
| | BASE |
| ATTACHMENT HEAD | RₓR_{y} ATTACHMENT |
| RECEIVING OPTICAL UNIT 1 | PSA Open |
| RECEIVING OPTICAL UNIT 2 | RECEIVING SOLAR SLIT 5.0° |
| DIRECT BEAM STOPPER | NOT USED |
| DETECTOR | HYBRID-TYPE MULTI- |
| | DIMENSIONAL PIXEL DETECTOR |
| | HyPix-3000 HE (ZERO- |
| | DIMENSIONAL MODE) |

TABLE 2
MEASUREMENT CONDITIONS

| | |
|---|---|
| MEASUREMENT MODE | 0D (SCAN) |
| ENERGY MODE | STANDARD MODE |
| SCAN AXIS | 2θ |
| SCAN RANGE | 0.0° ≤ 2θ ≤ 2.0° |
| STEP | 0.0008° |
| SPEED | 0.1°/min |
| INCIDENT SLIT | 0.05 mm |
| RECEIVING SLIT 1 | 0.25 mm |
| RECEIVING SLIT 2 | 0.30 mm |
| MEASUREMENT TIME | 20 min |

The displaying section 260 causes measurement data to be displayed on the display apparatus 520. Thereby, a user can confirm the measurement data. Furthermore, the user can make an instruction or specification to the control apparatus 200 based on the measurement data. Furthermore, it is possible to display a structure factor and a PDF by being connected to the processing apparatus 100.

### [X-Ray Diffractometer]

The X-ray diffractometer 300 mainly includes an X-ray generating section 310 that generates an X-ray from an X-ray focus, that is, an X-ray source, an incidence-side optical unit 320, a goniometer 330, a sample stage 340 where a sample is arranged, an irradiation-side optical unit 350, and an X-ray detector 360 that detects an X-ray.

It is preferable that, in the case of performing measurement of total scattering data, the X-ray generating section 310 uses a high-energy radiation source using silver, molybdenum, or the like as target metal. In the case of performing measurement by the X-ray reflectivity measurement method, it is preferable to use a low-energy radiation source using copper. In the case of performing measurement of total scattering data and measurement by the X-ray reflectivity measurement method using the same apparatus, however, it is preferable to use molybdenum as target metal. Note that description of the incidence-side optical unit 320, the goniometer 330, the sample stage 340, the irradiation-side optical unit 350, and the X-ray detector 360 will be omitted because conventional ones can be used.

### [Measurement Method and Program]

A sample is placed on the X-ray diffractometer 300, and the goniometer 330 is driven under predetermined conditions, based on control by the control apparatus 200. Furthermore, an X-ray is caused to be incident on the sample, and a diffracted X-ray occurring from the sample is detected. Thereby, diffraction data is acquired. The X-ray diffractometer 300 transmits apparatus information and the like, and the acquired diffraction data to the control apparatus 200 as measurement data. It is possible to, for such measurement data, calculate the structure factor of a film portion formed on a substrate using the processing apparatus 100, computing system 10, method, and/or program of the present invention. A detailed description will be made below.

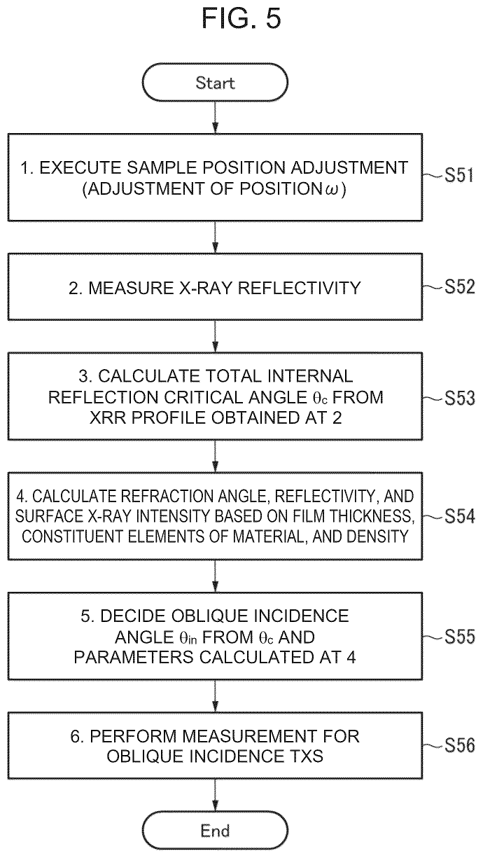

First, a sample position adjustment process will be described with reference to FIG. 5. The sample position adjustment process is a process for determining density p of the film portion and an incidence angle θ in, and the process is executed mainly by the controlling section 210, the sample information acquiring section 250, and the X-ray diffractometer 300.

When the process is started, the X-ray diffractometer 300 controlled by the controlling section 210 adjusts the position of a sample placed on the sample stage 340 first at step S51.

At the next step S52, the sample information acquiring section 250 executes the X-ray reflectivity measurement method using the X-ray diffractometer 300 to measure the X-ray reflectivity of the sample.

At the next step S53, the sample information acquiring section 250 calculates a total internal reflection critical angle θ_{c} using the X-ray reflectivity obtained at step S52.

At the next step S54, the sample information acquiring section 250 reads constituent elements of the film portion and a composition ratio from the apparatus information storing section 220, calculates the density p of the film portion based thereon, and, furthermore, calculates a refraction angle θ_{R} of the film portion based thereon.

At the next step S55, the sample information acquiring section 250 decides an oblique incidence angle θᵢₙ using the total internal reflection critical angle θ_{c} obtained at step S53 and the density p of the film portion obtained at step S54.

Then, at step S56, the controlling section 210 and the X-ray diffractometer 300 performing measurement of total scattering data using the oblique incidence angle θᵢₙ obtained at step S53. Then, the process ends.

The sample position adjustment process may be carried out as a computer program or may be stored in a storage medium as a computer program.

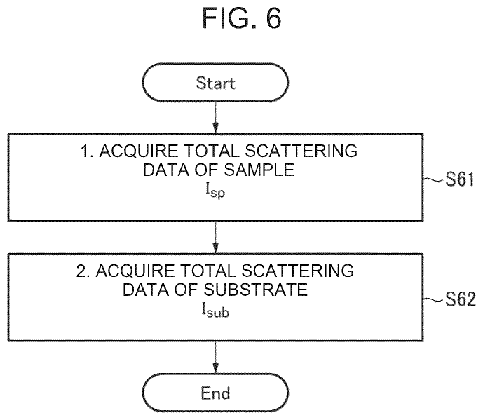

Next, a measurement process will be described with reference to FIG. 6. The measurement process is a process for obtaining total scattering data of the sample including the film portion and the substrate and total scattering data only of the substrate, using the density ρ of the film portion and the incidence angle θᵢₙ relative to the sample, which have been obtained by the sample position adjustment process. The process is executed mainly by the controlling section 210, the sample information acquiring section 250, and the X-ray diffractometer 300.

When the process is started, the X-ray diffractometer 300 drives the goniometer 330 against the first sample placed on the sample stage 340 under the predetermined conditions, based on control by the controlling section 210 first at step S61. Then, the X-ray diffractometer 300 causes an X-ray to be incident on the sample from the irradiation-side optical unit 350, and detects a diffracted X-ray occurring from the sample using the X-ray detector 360. Data obtained thereby is diffraction data. The X-ray diffractometer 300 changes the position of the irradiation-side optical unit 350 relative to the sample to detect the diffracted X-ray at a plurality of positions. Thereby, total scattering data Iₛₚ of the sample is obtained. The total scattering data Iₛₚ of the sample is transmitted to the measurement data storing section 240 and stored.

At the next step S62, the X-ray diffractometer 300 drives the goniometer 330 against only the substrate placed on the sample stage 340 under predetermined conditions, based on control by the controlling section 210. Then, the X-ray diffractometer 300 causes an X-ray to be incident on the substrate from the irradiation-side optical unit 350, and detects a diffracted X-ray occurring from the substrate using the X-ray detector 360. Data obtained thereby is diffraction data. The X-ray diffractometer 300 changes the position of the X-ray detector 360 relative to the substrate to detect diffracted X-rays at a plurality of positions. Thereby, the total scattering data I_{sub} of only the substrate is obtained. The total scattering data I_{sub} of only the substrate is transmitted to the measurement data storing section 240 and stored. After that, the process ends.

Note that steps S61 and S62 do not have to be executed in the above order. Step S61 may be executed after step S62, or steps S61 and S62 may be executed at the same time.

The measurement process may be carried out as a computer program or may be stored in a storage medium as a computer program.

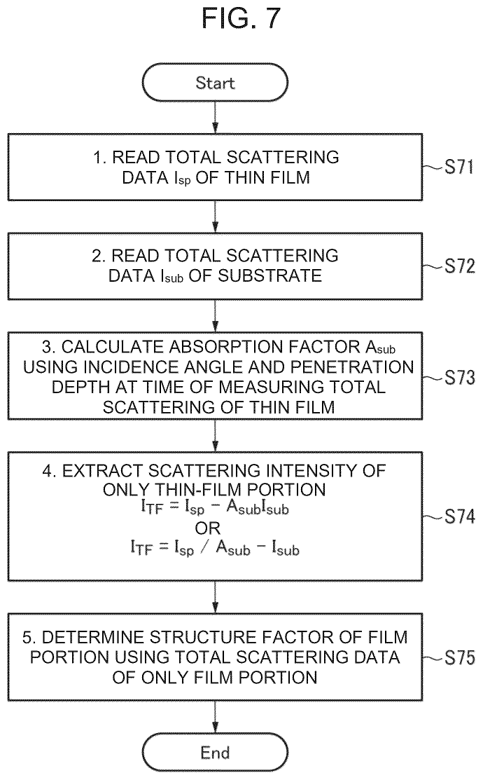

Next, a total scattering data acquisition process will be described with reference to FIG. 7. The total scattering data acquisition process is a process for obtaining total scattering data of only the film portion from the total scattering data of the sample including the film portion and the substrate and the total scattering data of only the substrate, which have been obtained by the measurement process, to determine a structure factor of the film portion, and is executed mainly by the processing apparatus 100.

When the process is started, the measurement data acquiring section 110 acquires the total scattering data Iₛₚ of the sample including the film portion and the substrate from the measurement data storing section 240 first at step S71.

Next, at step S72, the measurement data acquiring section 110 acquires the total scattering data I_{sub} of only the substrate from the measurement data storing section 240.

At the next step S73, the total scattering data calculating section 120 reads the absorption coefficient UTE of the film portion, the thickness t_{TF} of the film portion, the incidence angle θ_{R} of the X-ray relative to the film portion, and the diffraction angle 2θ from the apparatus information storing section 220 and the sample information acquiring section 250 first and calculates an absorption factor A_{sub} of the substrate.

At the next step S74, the total scattering data calculating section 120 acquires the total scattering data Iₛₚ and the total scattering data I_{sub} from the measurement data acquiring section 110, and calculates total scattering data I_{TF} of only the film portion based thereon.

At the next step S75, the structure factor calculating section 130 determines the structure factor of the film portion using the total scattering data I_{TF} of only the film portion. The determined structure factor is stored into the measurement data storing section 240. Then, the process ends.

Note that, the structure factor of the film portion is transmitted to the display apparatus 520 and is displayed either as the state of the structure factor or in the form of a PDF.

Here, the total scattering data acquisition process may be carried out as a computer program or may be stored in a storage medium as a computer program.

### Example

Total scattering data of an ITO film formed on a glass substrate was measured using the computing system 10. Table 3 shows the configuration of an apparatus used in the present example, and Table 4 shows conditions for the measurement.

TABLE 3
APPARATUS CONFIGURATION

| | |
|---|---|
| X-RAY SOURCE | Mo Kα (λ = 0.7107 Å) |
| FILAMENT TYPE | FINE FOCUS |
| TUBE VOLTAGE-TUBE | 60 kV-150 mA |
| CURRENT | |
| GONIOMETER RADIUM | 300 mm |
| OPTICAL SYSTEM | PB (PARABOLIC MULTILAYER |
| | MIRROR) |
| CBO + SELECTION SLIT | CBO + PB |
| INCIDENT OPTICAL UNIT | INCIDENT SOLAR SLIT 5.0° |
| INCIDENT LENGTH LIMIT | 10 mm |
| SLIT | |
| INCIDENCE-SIDE | NOT USED |
| SCATTERING CUTOFF | |
| PARTS | |
| ATTACHMENT BASE | STANDARD ATTACHMENT |
| | BASE |
| ATTACHMENT HEAD | RₓR_{y} ATTACHMENT |
| RECEIVING OPTICAL UNIT 1 | PSA 0.5° |
| RECEIVING OPTICAL UNIT 2 | RECEIVING SOLAR SLIT 5.0° |
| DIRECT BEAM STOPPER | NOT USED |
| DETECTOR | HYBRID-TYPE MULTI- |
| | DIMENSIONAL PIXEL DETECTOR |
| | HyPix-3000 HE (ZERO- |
| | DIMENSIONAL MODE) |

TABLE 4
MEASUREMENT CONDITIONS

| | |
|---|---|
| MEASUREMENT MODE | 0D (SCAN) |
| ENERGY MODE | STANDARD MODE |
| SCAN AXIS | 2θ |
| SCAN RANGE | 3.0° ≤ 2θ ≤ 159° |
| STEP | 0.10° |
| SPEED | 0.5°/min |
| INCIDENT SLIT | 0.05 mm |
| RECEIVING SLIT 1 | 20 mm |
| RECEIVING SLIT 2 | 20.1 mm |
| MEASUREMENT TIME | 10 HOURS (ACCUMULATED TWICE) |

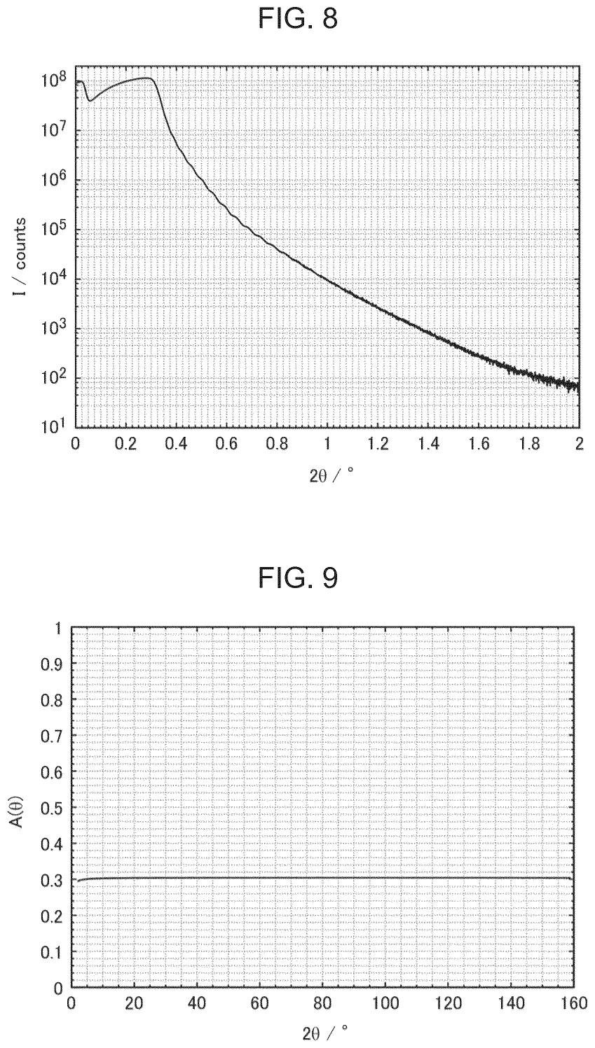

FIG. 8 shows a result of measurement by the X-ray reflectivity measurement method performed with a Moka wavelength (0.7107 Å). As a result of analysis, the film thickness and density of the ITO film were calculated as 77.6 nm and 6.62 g/cm³. From the result, the total internal reflection critical angle θ_{c} was calculated as 0.1602° (δ=3.91×10⁻⁶, B=8.60×10⁻⁸).

In consideration of the above result, the incidence angle θᵢₙ relative to the sample was set to 0.17°, which is a value a little larger than 0.1602°, the value of the total internal reflection critical angle θ_{c}, as a measurement condition for total scattering data. Then, when the value was substituted into Formulas (5) and (7), 0.0567° and 65.64 nm were obtained as the values of the incidence angle θ_{R} relative to the film portion and the penetration depth lₚ, respectively.

Here, FIG. 9 shows a relationship between a diffraction angle 2θ and an absorption factor A(θ) of the substrate determined based on total scattering data measured only for the substrate. Since the absorption factor A(θ) of the substrate was approximately 0.3 within almost the entire diffraction angle range, it was seen that actual measurements include approximately 30% of influence of the glass substrate.

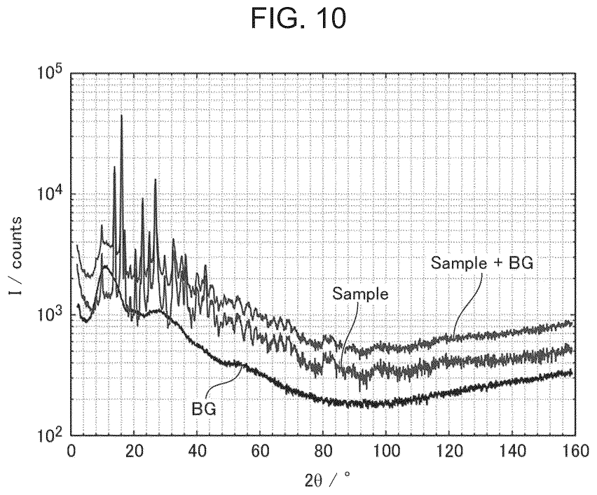

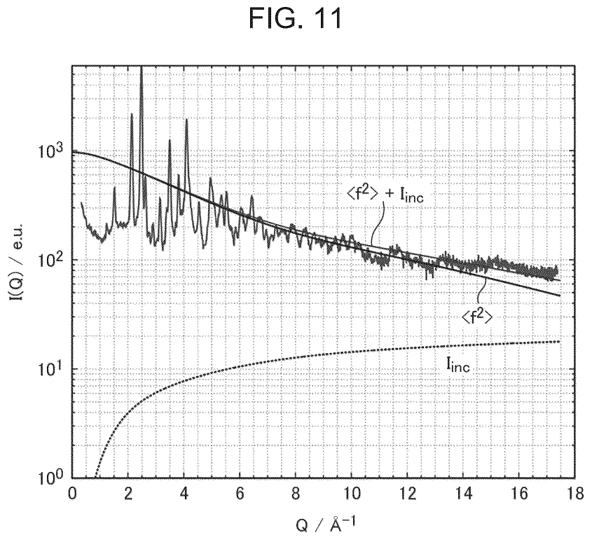

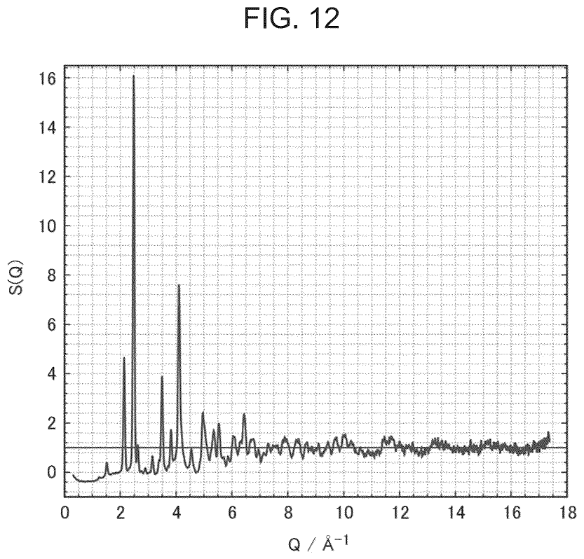

FIG. 10 shows total scattering data of the sample obtained by forming the ITO film on the glass substrate (a blue line), total scattering data of the glass substrate (a black line), and a result of extracting total scattering data of the film portion from the pieces of total scattering data (a red line). FIG. 11 shows scattering intensity of the sample normalized to an atomic scattering factor, and FIG. 12 shows the structure factor of the film portion. In general, whether correction for conversion to a structure factor is good or not is judged based on whether or not total scattering data overlaps with a total value of an atomic scattering factor and Compton scattering in high-frequency area. That is, if the structure factor is correctly calculated, the total scattering data overlaps with the total value of the atomic scattering factor and Compton scattering in high-frequency area. Since the total scattering data of the ITO film portion overlaps with a total value <f²>+I_{inc} of an atomic scattering factor <f²> and Compton scattering I_{inc} in a high-frequency area (equal to or higher than 12 Å⁻¹), it was seen that the correction was correctly calculated (see FIG. 11).

From the above result, the processing apparatus, method, and program of the present invention are capable of accurately calculating the structure factor of a film portion formed on a substrate, with the film portion being attached to the substrate.

In the method of the present invention, since it is not necessary for an X-ray to penetrate a substrate, a high-energy X-ray source is not required, and the type of the substrate is not restricted.

Furthermore, for example, if the conventional method described in A.-C. Dippel, M. Roelsgaard, U. Boettger, T. Schneller, O. Gutowski, U. Ruett, IUCrJ. 6 (2019) 290-298 is applied to a thin-film sample with a small film thickness, data that includes not only the scattering intensity of the thin-film sample but also the scattering intensity derived from the substrate is detected, and, thereby, there is a possibility that the scattering intensity of only the thin film formed on the substrate cannot be obtained. If the scattering intensity of only the thin film cannot be obtained, it is not possible to obtain an appropriate three-dimensional structure. According to the present invention, however, it is possible to, even if measurement data includes total scattering data derived from a substrate in addition to total scattering data of a film portion, accurately subtract the total scattering data derived from the substrate. Therefore, it is possible to, even in the case of a thin-film sample which necessarily includes total scattering data derived from a substrate, apply the present invention.

Furthermore, in order to obtain information about the three-dimensional structure of a thin-film sample provided on a substrate, it is necessary to obtain the scattering intensity of only the thin film formed on the substrate, and it is necessary to precisely decide the incidence angle θᵢₙ of an X-ray relative to the thin-film sample in order to eliminate influence of the scattering intensity derived from the substrate. However, it was seen that, according to the present invention, it is preferable that the X-ray incidence angle θᵢₙ relative to the sample is equal to or smaller than twice the total internal reflection critical angle θ_{c}. Thereby, it is possible to easily and precisely decide the incidence angle θᵢₙ of an X-ray.

In the method described in A.-C. Dippel, M. Roelsgaard, U. Boettger, T. Schneller, O. Gutowski, U. Ruett, IUCrJ. 6 (2019) 290-298, it is necessary to precisely control the incidence angle θᵢₙ in order to prevent the scattering intensity derived from a substrate from being detected, as described above. In this regard, since it is difficult to precisely control the incidence angle θᵢₙ if a synchrotron radiation with low parallelism is used, it is necessary to use output of a synchronous radiation facility with high parallelism. According to the present invention, however, since it is possible to precisely subtract the scattering intensity derived from a substrate, it is not necessary to use output of a synchronous radiation facility with high parallelism.

Note that the processing apparatus 100 may be, for example, a PC terminal or a cloud server. The whole processing apparatus 100 may be provided on a cloud, or a part of the processing apparatus 100 or a part of the functions of the processing apparatus 100 may be provided on the cloud.

Note that, though the description has been made on the assumption that total scattering data of a sample is measured by the X-ray diffractometer 300, the total scattering data of a sample may be acquired by an apparatus other than the X-ray diffractometer 300, which is capable of acquiring the total scattering data of a sample.

Note that, in Formulas (1) and (2), scattering intensity may be used instead of total scattering data. The effects described above can be obtained even if scattering intensity is used.

Note that the processing apparatus 100 and the control apparatus 200 may be provided in one computer. In this case, the processing apparatus 100 and the control apparatus 200 share an input apparatus and a display apparatus.

Note that the size, shape, and quantity of each member shown in the present specification and the drawings are exemplifications, and the size, shape, and quantity of each member are not limited thereto. Furthermore, the material of each member is an exemplification, and the material of each member is not limited thereto.

An embodiment of the present invention has been described with reference to accompanying drawings. It is, however, obvious to those skilled in the art that the structure of each section and relationships among the sections can be modified without departing from the scope and spirit of the described invention.
10 computing system
100 processing apparatus
110 measurement data acquiring section
120 total scattering data calculating section
130 structure factor calculating section
200 control apparatus
210 controlling section
220 apparatus information storing section
230 measurement condition deciding section
240 measurement data storing section
250 sample information acquiring section
260 displaying section
300 X-ray diffractometer
310 X-ray generating section
320 incidence-side optical unit
330 goniometer
340 sample stage
350 irradiation-side optical unit
360 X-ray detector
510 input apparatus
520 display apparatus
610 input apparatus
620 display apparatus

1. A processing apparatus for calculating a structure factor of a film portion formed on a substrate, the processing apparatus comprising:
processing circuitry configured to
acquire first total scattering data obtained by performing measurement for a first sample including the substrate and the film portion under a measurement condition of an X-ray being obliquely incident, and second total scattering data obtained by performing measurement for a second sample including the first sample except the film portion under the measurement condition;
calculate total scattering data of the film portion based on the first total scattering data and the second total scattering data; and
calculate a structure factor of the film portion based on the total scattering data of the film portion.

2. The processing apparatus according to claim 1, wherein the processing circuitry is further configured to
calculate the total scattering data of the film portion by subtracting a product of the second total scattering data and an absorption factor of the substrate from the first total scattering data.

3. The processing apparatus according to claim 2, wherein the processing circuitry is further configured to
calculate the absorption factor of the substrate based on an X-ray incidence angle, diffraction angle, film thickness of the film portion, an absorption coefficient of the film portion, and/or a refractive index of the film portion.

4. The processing apparatus according to claim 1, wherein the measurement condition has information about an X-ray incidence angle, and the X-ray incidence angle is equal to or smaller than twice a total internal reflection critical angle.

5. A system comprising:
an X-ray diffractometer comprising an X-ray generator generating an X-ray, an X-ray detector detecting the X-ray, a sample stage where a sample is arranged, and a goniometer controlling an angle formed by the X-ray generated by the X-ray generator and a surface of the sample and an angle formed by the X-ray received by the X-ray detector and the surface of the sample; and
the processing apparatus according to claim 1, wherein
the X-ray diffractometer generates the first total scattering data and the second total scattering data using the X-ray generator, the X-ray detector, and the goniometer.

6. The system according to claim 5, wherein the processing circuitry is further configured to
decide the measurement condition including information about an X-ray incidence angle, and
decide X-ray incidence angles for the first sample and the second sample based on film thickness of the film portion, an absorption coefficient of the film portion, and/or a total internal reflection critical angle between the first sample and the X-ray.

7. The system according to claim 6, wherein the processing circuitry is further configured to
determine the film thickness of the film portion and a density of the film portion or the total internal reflection critical angle of the film portion by an X-ray reflectivity measurement method based on the data obtained using the X-ray diffractometer.

8. The system according to claim 5, wherein the processing circuitry is further configured to
determine correlation among atoms included in the film portion based on the structure factor of the film portion.

9. A non-transitory computer-readable storage medium storing a program for calculating a structure factor of a film portion formed on a substrate, the program being executed by a computer and comprising:
acquiring first total scattering data obtained by performing measurement for a first sample including the substrate and the film portion under a measurement condition of an X-ray being obliquely incident;
acquiring second total scattering data obtained by performing measurement for a second sample including the first sample except the film portion under the measurement condition;
calculating total scattering data of the film portion based on the first total scattering data and the second total scattering data; and
calculating a structure factor of the film portion based on the total scattering data of the film portion.

10. A method for calculating a structure factor of a film portion formed on a substrate, the method comprising:
acquiring first total scattering data obtained by performing measurement for a first sample including the substrate and the film portion under a measurement condition of an X-ray being obliquely incident;
acquiring second total scattering data obtained by performing measurement for a second sample including the first sample except the film portion under the measurement condition;
calculating total scattering data of the film portion based on the first total scattering data and the second total scattering data; and
calculating a structure factor of the film portion based on the total scattering data of the film portion.
